(19) United States
(12) Patent Application Publication
(10) Pub. No.: US 2026/0046044 A1
(43) Pub. Date: Feb. 12, 2026

(54) RADIO FREQUENCY (RF) BLOCKER DETECTION IN AN RF FRONTEND CIRCUIT

(71) Applicant: Qorvo US, Inc., Greensboro, NC (US)

(72) Inventors: George Maxim, Saratoga, CA (US); Nadim Khlat, Cugnaux (FR); Baker Scott, San Jose, CA (US)

(21) Appl. No.: 18/995,820

(22) PCT Filed: Jul. 26, 2023
(86) PCT No.: PCT/US2023/028663

§ 371 Date: Jan. 16, 2025

Related U.S. Application Data
(60) Provisional application No. 63/393,565, filed on Jul. 29, 2022.

(51) Int. Cl. H04B 17/318

(52) U.S. Cl. CPC H04B 17/318

(57) ABSTRACT

Radio frequency (RF) blocker detection in an RF frontend circuit is provided. In embodiments disclosed herein, the RF frontend circuit includes multiple detector circuits configured to measure strength of a received RF signal at multiple measurement points of an RF receive path and report the measured strength at each of the measurement points to a blocker detection circuit. Based on the measured strength at various measurement points, the blocker detection circuit can determine a presence and location of an RF blocker(s) inside or outside a signal passband of the received RF signal. Accordingly, the blocker detection circuit can take a corrective action locally and/or report the detected RF blocker(s) to a transceiver circuit to trigger proper corrective actions in the transceiver circuit. As a result, it is possible to block or suppress the RF blocker(s) around the signal passband to help improve receiver sensitivity of the RF receive path.

### RELATED APPLICATIONS

This application claims the benefit of U.S. provisional patent application Ser. No. 63/393,565, filed on Jul. 29, 2022, the disclosure of which is hereby incorporated herein by reference in its entirety.

### FIELD OF THE DISCLOSURE

The technology of the disclosure relates generally to detecting a radio frequency (RF) blocker band(s) and/or signal(s) in an RF frontend circuit.

### BACKGROUND

Wireless communication devices have become increasingly common in current society. The prevalence of these wireless communication devices is driven in part by the many functions that are now enabled on such devices.

Increased processing capabilities in such devices means that wireless communication devices have evolved from being pure communication tools into sophisticated multimedia centers that enable enhanced user experiences.

A state-of-the-art wireless communication device typically supports a variety of wireless communication systems for enabling a variety of wireless communication applications. For example, in addition to supporting fifth generation (5G) and/or 5G new radio (5G-NR) for long-range wireless communications, the wireless communication device also needs to support short-range wireless communications based on a variety of alternative wireless communication technologies, such as Wi-Fi, Bluetooth, ultra-wideband (UWB), ZigBee, and so on,

As a radio frequency (RF) spectrum suitable for wireless communications is scarce, many of the long-range and short-range wireless communication systems are forced to share the radio spectrum. For example, certain 5G/5G-NR bands (e.g., band 41) may overlap with the Industrial, Scientific, and Medical (ISM) band already shared among Wi-Fi, Bluetooth, and ZigBee. In this regard, any RF signal transmitted in or near a shared RF spectrum may become an RF blocker that hinders the ability of a radio receiver to correctly receive an RF signal being in or near the shared RF spectrum. As such, it is desirable to detect the RF blocker around the shared RF spectrum to help avoid or mitigate potential desensing in an RF receiver.

### SUMMARY

Aspects disclosed in the detailed description include radio frequency (RF) blocker detection in an RF frontend circuit. In various embodiments disclosed herein, the RF frontend circuit includes multiple detector circuits configured to measure strength of a received RF signal at multiple measurement points of an RF receive path and report the measured strength at each of the measurement points to a blocker detection circuit. Based on the measured strength at various measurement points, the blocker detection circuit can determine a presence and location of an RF blocker(s) inside or outside a signal passband of the received RF signal. Accordingly, the blocker detection circuit can take a corrective action locally and/or report the detected RF blocker(s) to a transceiver circuit to trigger proper corrective actions in the transceiver circuit. As a result, it is possible to block or suppress the RF blocker(s) around the signal passband to help improve receiver sensitivity of the RF receive path.

In one aspect, an RF frontend circuit is provided. The RF frontend circuit includes at least one RF receive path. The at least one RF receive path is configured to receive an RF signal in a signal passband. The RF frontend circuit also includes multiple detector circuits. Each of the multiple detector circuits is coupled to a respective one of multiple measurement points in the RF receive path. Each of the multiple detector circuits is configured to report a respective one of multiple measured strengths of the RF signal detected at the respective one of the multiple measurement points. The RF frontend circuit also includes a blocker detection circuit. The blocker detection circuit is coupled to the multiple detector circuits. The blocker detection circuit is configured to determine, based on the multiple measured strengths of the RF signal, whether one or more RF blockers are present relative to the signal passband.

In another aspect, a method for detecting an RF blocker in a signal passband is provided. The method includes receiving an RF signal in the signal passband. The method also includes reporting multiple measured strengths of the RF signal detected at multiple measurement points, respectively. The method also includes determining, based on the multiple measured strengths of the RF signal, whether one or more RF blockers are present relative to the signal passband.

Those skilled in the art will appreciate the scope of the disclosure and realize additional aspects thereof after reading the following detailed description in association with the accompanying drawings.

### BRIEF DESCRIPTION OF THE DRAWINGS

The accompanying drawings incorporated in and forming a part of this specification illustrate several aspects of the disclosure and, together with the description, serve to explain the principles of the disclosure.

FIG. 1 is a schematic diagram providing an exemplary illustration of various radio frequency (RF) blockers that may interfere with a desired signal to be received in a signal passband;

FIG. 2 is a schematic diagram of an exemplary RF frontend circuit configured according to various embodiments of the present disclosure to detect the RF blockers in FIG. 1;

FIGS. 3A and 3B provide exemplary illustrations as to how the RF frontend circuit of FIG. 2 can detect an in-band RF blocker;

FIGS. 4A-4C provide exemplary illustrations as to how the RF frontend circuit of FIG. 2 can detect a location of the in-band RF blocker detected in FIGS. 3A and 3B;

FIG. 5 is an exemplary blocker detection table establishing a set of rules that can be employed by the RF front-end circuit of FIG. 2 for detecting one or more out-band RF blockers;

FIGS. 6A and 6B provide exemplary illustrations as to how the RF frontend circuit of FIG. 2 can detect one or more out-band RF blockers at a notch frequency;

FIGS. 7A and 7B provide exemplary illustrations as to how the RF frontend circuit of FIG. 2 can detect one or more out-band RF blockers in a rejected band of a band reject filter;

FIG. 8 is a schematic diagram of an exemplary RF frontend circuit configured according to another embodiment of the present disclosure to concurrently detect the RF blockers in FIG. 1 in multiple RF signals;

FIG. 9 is a schematic diagram of an exemplary RF frontend circuit configured according to another embodiment of the present disclosure to concurrently detect the RF blockers in FIG. 1 in multiple RF signals across multiple RF bands;

FIG. 10 is a schematic diagram of an exemplary user element wherein the RF frontend circuits of FIGS. 2, 8, and 9 can be provided; and

FIG. 11 is a flowchart of an exemplary process whereby the RF frontend circuit of FIG. 2 can detect the RF blockers in FIG. 1.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Aspects disclosed in the detailed description include radio frequency (RF) blocker detection in an RF frontend circuit. In various embodiments disclosed herein, the RF frontend circuit includes multiple detector circuits configured to measure strength of a received RF signal at multiple measurement points of an RF receive path and report the measured strength at each of the measurement points to a blocker detection circuit. Based on the measured strength at various measurement points, the blocker detection circuit can determine a presence and location of an RF blocker(s) inside or outside a signal passband of the received RF signal. Accordingly, the blocker detection circuit can take a corrective action locally and/or report the detected RF blocker(s) to a transceiver circuit to trigger proper corrective actions in the transceiver circuit. As a result, it is possible to block or suppress the RF blocker(s) around the signal passband to help improve receiver sensitivity of the RF receive path.

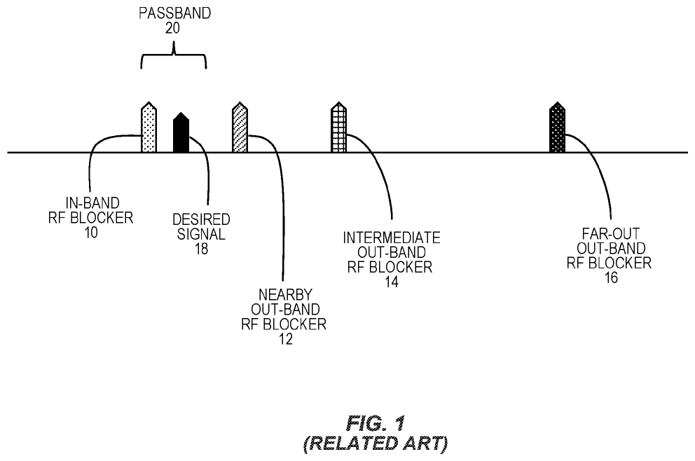

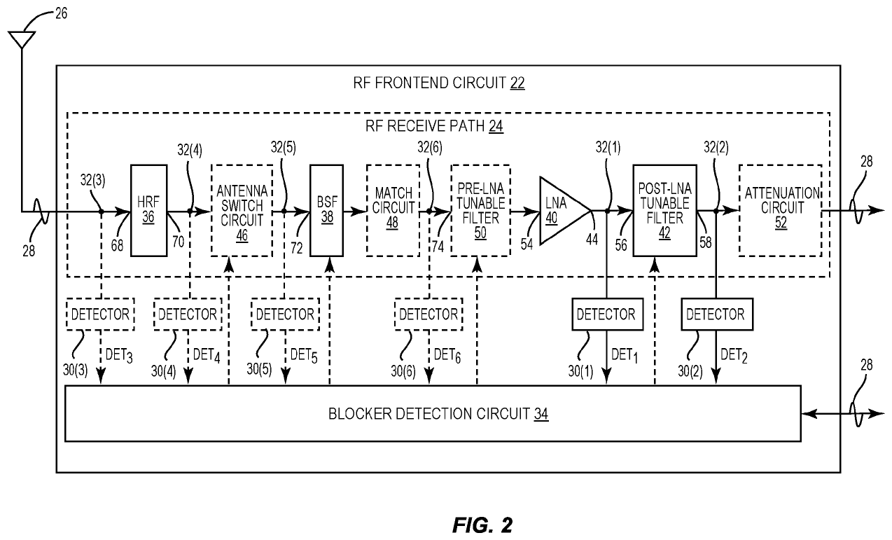

Before discussing the RF frontend circuit of the present disclosure, starting at FIG. 2, a brief overview of various RF blockers that may be detected via the RF frontend circuit is first provided with reference to FIG. 1.

FIG. 1 is a schematic diagram providing an exemplary illustration of various RF blockers 10, 12, 14, 16 that may interfere with a desired signal 18 to be received in a signal passband 20. Herein, the RF blocker 10 either falls within or overlaps with the signal passband 20 and is thus referred to as an “in-band RF blocker” hereinafter. The RF blockers 12, 14, and 16 are all located outside (a.k.a. non-overlap) the signal passband 20 and are thus referred to as “out-band RF blockers” hereinafter. Among the RF blockers 12, 14, and 16, the RF blocker 12 is further referred to as a “nearby out-band RF blocker,” the RF blocker 14 is further referred to as an “intermediate out-band RF blocker,” and the RF blocker 16 is further referred to as a “far-out out-band RF blocker.” As illustrated, the nearby out-band RF blocker is closer to, but not overlapping with, the signal passband 20, the intermediate out-band RF blocker 14 is farther away from the signal passband 20 than the nearby out-band RF blocker 12, and the far-out out-band RF blocker 16 is farther away from the signal passband 20 than the intermediate out-band RF blocker 14.

Among the RF blockers 10, 12, 14, and 16, the in-band RF blocker 10 and the nearby out-band RF blocker 12 are particularly harmful to the desired signal 18 in the signal passband 20. Specifically, the in-band RF blocker 10 may not be completely suppressed by a bandpass filter tuned to pass the desired signal 18 to the signal passband 20 and can thus become too strong to overwhelm the desired signal 18 in the signal passband 20. The nearby out-band RF blocker 12, on the other hand, can create intermodulation products that fall inside or overlap with the signal passband 20. As such, it is desirable to detect the RF blockers 10, 12, 14, and 16 and take appropriate corrective action accordingly to protect the desired signal 18 in the signal passband 20.

FIG. 2 is a schematic diagram of an exemplary RF frontend circuit 22 configured according to various embodiments of the present disclosure to detect the RF blockers 10, 12, 14, and 16 in FIG. 1. The RF frontend circuit 22 includes an RF receive path 24, which is coupled to an antenna circuit 26 to receive an RF signal 28. Herein, the RF frontend circuit 22 is configured to measure a respective strength, such as received signal power, signal-to-noise ratio (SNR), and signal-to-interference-and-noise ratio (SINR), of the RF signal 28 at multiple measurement points. As described in detail below, the RF frontend circuit 22 can then determine a presence or absence of some or all of the RF blockers 10, 12, 14, and 16 based on the measured strength of the RF signal 28 at different measurement points.

The RF frontend circuit 22 includes at least a first detector circuit 30(1) and a second detector circuit 30(2). The first detector circuit 30(1) is coupled to a first measurement point 32(1) in the RF receive path 24 to report a first measured strength DET₁ of the RF signal 28 at the first measurement point 32(1). Likewise, the second detector circuit 30(2) is coupled to a second measurement point 32(2) in the RF receive path 24 to report a second measured strength DET₂ of the RF signal 28 at the second measurement point 32(2).

The RF frontend circuit 22 may optionally include additional detector circuits to measure the strength of the RF signal 28 at additional measurement points in the RF receive path 24. In a non-limiting example, the RF frontend circuit 22 can further include any combination of a third detector circuit 30(3), a fourth detector circuit 30(4), a fifth detector circuit 0(5), and a sixth detector circuit 30(6). The third detector circuit 30(3), the fourth detector circuit 30(4), the fifth detector circuit 30(5), and the sixth detector circuit 30(6) are coupled, respectively, to a third measurement point 32(3), a fourth measurement point 32(4), a fifth measurement point 32(5), and a sixth measurement point 32(6) in the RF receive path 24 to measure the strength of the RF signal 28 at the said measurement points. Accordingly, the third detector circuit 30(3), the fourth detector circuit 30(4), the fifth detector circuit 30(5), and the sixth detector circuit 30(6) can report a third measured strength DET₃, a fourth measured strength DET₄, a fifth measured strength DET₅, and a sixth measured strength DET₆, respectively. Notably, the third measured strength DET₃, the fourth measured strength DET₄, the fifth measured strength DET₅, and the sixth measured strength DET₆ will provide indications of the strength of the RF signal 28 measured at the third measurement point 32(3), the fourth measurement point 32(4), the fifth measurement point 32(5), and the sixth measurement point 32(6) in the RF receive path 24, respectively.

The RF frontend circuit 22 also includes a blocker detection circuit 34, which can be a field-programmable gate array (FPGA), as an example. The blocker detection circuit 34 is coupled to the first detector circuit 30(1), the second detector circuit 30(2), and optionally the third detector circuit 30(3), the fourth detector circuit 30(4), the fifth detector circuit 30(5), and the sixth detector circuit 30(6). As such, the blocker detection circuit 34 can receive the first measured strength DET₁, the second measured strength DET₂, and optionally the third measured strength DET₃, the fourth measured strength DET₄, the fifth measured strength signal DET₅, and the sixth measured strength DET₆.

As described in further detail below, the blocker detection circuit 34 can analyze the respective strength of the RF signal 28 as measured at the different measurement points in the RF receive path 24 to thereby determine a presence or absence of any of the RF blockers 10, 12, 14, and 16 illustrated in FIG. 1. In response to determining the presence of any of the RF blockers 10, 12, 14, and 16, the blocker detection circuit 34 may report the detected RF blockers 10, 12, 14, and 16 to a transceiver circuit (not shown), which will determine and instruct the blocker detection circuit 34 to take appropriate corrective action to mitigate a potential impact of the detected RF blockers 10, 12, 14, and 16. In addition to or alternative to reporting the detected RF blockers 10, 12, 14, and 16 to the transceiver circuit, the blocker detection circuit 34 may also autonomously determine and cause a local corrective action to be taken inside the RF frontend circuit 22 to combat the detected RF blockers 10, 12, 14, and 16. Thus, by detecting the RF blockers 10, 12, 14, and 16 in the RF frontend circuit 22, it is possible to block or suppress the RF blockers 10, 12, 14, and 16 around a signal passband of the RF signal 28 to help improve receiver sensitivity of the RF receive path 24.

According to an embodiment of the present disclosure, the RF receive path 24 includes a harmonic rejection filter (HRF) 36 that is coupled to the antenna circuit 26. The RF receive path 24 also includes a band select filter (BSF) 38 that is coupled to the HRF 36. The RF receive path 24 also includes a low-noise amplifier (LNA) 40 that is coupled to the BSF 38. The RF receive path 24 also includes a post-LNA tunable filter 42 coupled to an output 44 of the LNA 40. In a non-limiting example, the HRF 36 can be a notch filter or a band reject filter that is configured to reject harmonic components associated with the RF signal 28 received via the antenna circuit 26. In another non-limiting example, the BSF 38 can be a sharp acoustic filter that is configured to select the signal passband of the RF signal 28. In another non-limiting example, the post-LNA tunable filter can be a tunable blocker-reject filter to help eliminate any intermodulation product that may fall within or overlap with the signal passband.

In addition, the RF receive path 24 may also include an antenna switch circuit 46, a match circuit 48, a pre-LNA tunable filter 50, and an attenuation circuit 52. Herein, the antenna switch circuit 46 is coupled between the HRF 36 and the BSF 38. The match circuit 48 and the pre-LNA tunable filter 50 are coupled in tandem between the BSF 38 and an input 54 of the LNA 40. The attenuation circuit 52 is configured to couple the post-LNA tunable filter 42 to the transceiver circuit (not shown).

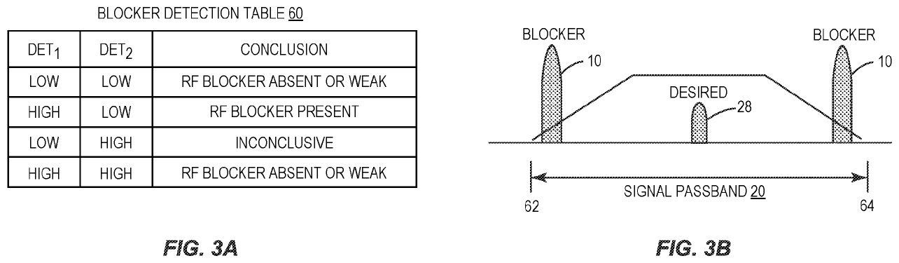

According to an embodiment of the present disclosure, the first measurement point 32(1) is located at an input 56 of the post-LNA tunable filter 42 and the second measurement point 32(2) is located at an output 58 of the post-LNA tunable filter 42. Accordingly, the first measured strength DET₁ can indicate the measured strength of the RF signal 28 at the input 56 of the post-LNA tunable filter 42 and the second measured strength DET₂ can indicate the measured strength of the RF signal 28 at the output 58 of the post-LNA tunable filter 42. As discussed in FIGS. 3A and 3B, the blocker detection circuit 34 can determine whether the in-band RF blocker 10 is present in the signal passband based on the measured strength of the RF signal 28 at the input 56 and the output 58 of the post-LNA tunable filter 42.

FIGS. 3A and 3B provide exemplary illustrations as to how the blocker detection circuit 34 in FIG. 2 can detect the in-band RF blocker 10 in FIG. 1 based on the measured strength of the RF signal 28 at the input 56 and the output 58 of the post-LNA tunable filter 42. Common elements between FIGS. 1, 2, 3A, and 3B are shown therein with common element numbers and will not be re-described herein.

FIG. 3A shows a blocker detection table 60 that establishes a set of rules for detecting the in-band RF blocker 10. Specifically, if the first measured strength DET₁ and the second measured strength DET₂ are both below an established threshold, or both above the established threshold, the blocker detection circuit 34 can then conclude that the in-band RF blocker 10 is either absent or too weak to interfere with the RF signal 28 in the signal passband. In contrast, if the first measured strength DET₁ is higher than the established threshold, while the second measured strength DET₂ is lower than the established threshold, the blocker detection circuit 34 can then conclude that the in-band RF blocker 10 is present inside the signal passband to potentially interfere with the RF signal 28. If, however, if the first measured strength DET₁ is lower than the established threshold, while the second measured strength DET₂ is higher than the established threshold, the blocker detection circuit 34 will not be able to conclusively determine whether the in-band RF blocker 10 is present or absent in the signal passband.

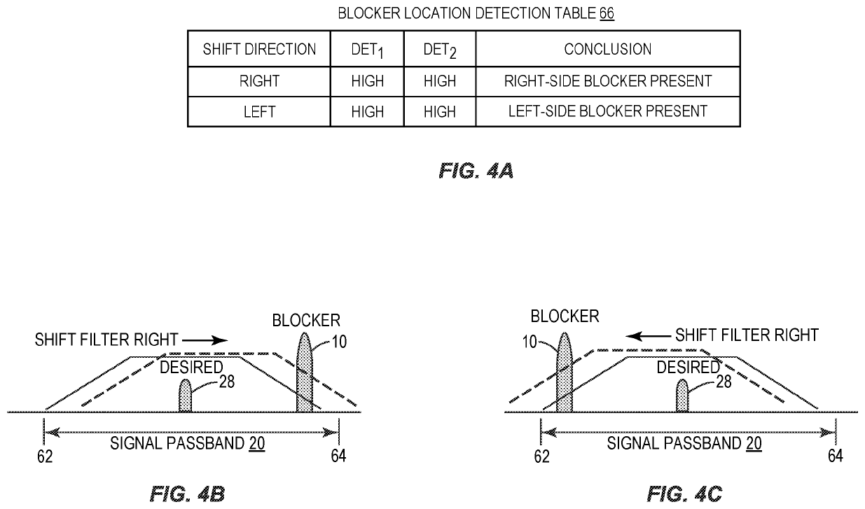

As shown in FIG. 3B, the in-band RF blocker 10, if present, may be located at a lower boundary 62 and/or an upper boundary 64 of the signal passband. As illustrated in FIGS. 4A-4C, the blocker detection circuit 34 may also determine an exact location of the in-band RF blocker 10.

FIGS. 4A-4C provide exemplary illustrations as to how the blocker detection circuit 34 in FIG. 2 can detect a location of the in-band RF blocker 10 detected in FIGS. 3A and 3B. Common elements between FIGS. 2, 3A, 3B, and 4A-4C are shown therein with common element numbers and will not be re-described herein.

FIG. 4A shows a blocker location detection table 66 that establishes a set of rules for detecting the location of the in-band RF blocker 10. FIG. 4B provides an exemplary illustration as to how the blocker detection circuit 34 can determine that the in-band RF blocker 10 is located at or close to the upper boundary 64 of the RF signal 28 of the signal passband 20. FIG. 4C provides an exemplary illustration as to how the blocker detection circuit 34 can determine that the in-band RF blocker 10 is located at or close to the lower boundary 62 of the RF signal 28 of the signal passband 20.

According to FIG. 4B, the blocker detection circuit 34 is configured to right shift the post-LNA tunable filter 42 toward the upper boundary 64 of the signal passband. The blocker detection circuit 34 will then reexamine the first measured strength DET₁ and the second measured strength DET₂. According to the rules set in the blocker location detection table 66, the blocker detection circuit 34 can determine that the in-band RF blocker 10 is located at or close to the upper boundary 64 of the signal passband if the first measured strength DET₁ and the second measured strength DET₂ are both above an established threshold.

According to FIG. 4C, the blocker detection circuit 34 is configured to left shift the post-LNA tunable filter 42 toward the lower boundary 62 of the signal passband. The blocker detection circuit 34 will then reexamine the first measured strength DET₁ and the second measured strength DET₂. According to the rules set in the blocker location detection table 66, the blocker detection circuit 34 can determine that the in-band RF blocker 10 is located at or close to the lower boundary 62 of the signal passband 20 if the first measured strength DET₁ and the second measured strength DET₂ are both above an established threshold.

With reference back to FIG. 2 and according to an embodiment of the present disclosure, the third measurement point 32(3) may be located at an input 68 of the HRF 36, the fourth measurement point 32(4) may be located at an output 70 of the HRF 36, the fifth measurement point 32(5) may be located at an input 72 of the BSF 38, and the sixth measurement point 32(6) may be located at an input 74 of the pre-LNA tunable filter 50. Accordingly, the third detector circuit 30(3) can report the third measured strength DET₃, the fourth detector circuit 30(4) can report the fourth measured strength DET₄, the fifth detector circuit 30(5) can report the fifth measured strength DET₅, and the sixth detector circuit 30(6) can report the sixth measured strength DET₆. Herein, the third measured strength DET₃ indicates the measured strength of the RF signal 28 at the input 68 of the HRF 36, the fourth measured strength DET₄ indicates the measured strength of the RF signal 28 at the output 70 of the HRF 36, the fifth measured strength DET₄ indicates the measured strength of the RF signal 28 at the input 72 of the BSF 38, and the sixth measured strength DET₆ indicates the measured strength of the RF signal 28 at the input 72 of the pre-LNA tunable filter 50. As discussed below, based on additional measured strengths of the RF signal 28 reported by the detector circuits 30(3)-30(6), the blocker detection circuit 34 can further determine a presence or absence of the out-band RF blockers 12, 14, and 16 in FIG. 1.

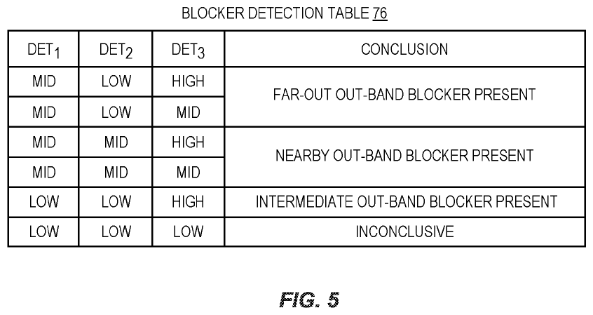

FIG. 5 is an exemplary blocker detection table 76 establishing a set of rules that can be employed by the blocker detection circuit in FIG. 2 for detecting the out-band RF blockers 12, 14, and 16 in FIG. 1. Common elements between FIGS. 2 and 5 are shown therein with common element numbers and will not be re-described herein.

In an embodiment, the blocker detection circuit 34 may first establish a set of thresholds. In a non-limiting example, the blocker detection circuit 34 can establish a lower threshold, a medium threshold higher than the lower threshold, and a higher threshold higher than the medium threshold. Herein, the blocker detection circuit 34 is configured to determine a presence or absence of the out-band RF blockers 12, 14, and/or 16 based at least on the first measured strength DET₁, the second measured strength DET₂, and the third measured strength DET₃, in conjunction with the established thresholds.

According to the blocker detection table 76, the blocker detection circuit 34 may conclude that the nearby out-band RF blocker 12 is present outside the signal passband 20 in case the first measured strength DET₁ and the second measured strength DET₂are equal to the medium threshold, while the third measured strength DET₃ is equal to the medium threshold or the higher threshold.

Also, according to the blocker detection table 76, the blocker detection circuit 34 may conclude that the far-out out-band RF blocker 16 is present outside the signal passband 20 in case the first measured strength DET₁ is equal to the medium threshold, the second measured strength DET₂ is equal to the lower threshold, and the third measured strength DET₃ is equal to the medium threshold of the higher threshold.

Further according to the blocker detection table 76, the blocker detection circuit 34 may conclude that the intermediate out-band RF blocker 14 is present outside the signal passband in case the first measured strength DET₁ and the second measured strength DET₂ are both equal to the lower threshold, and the third measured strength DET₃ is equal to the higher threshold.

If, however, the first measured strength DET₁, the second measured strength DET₂ and the third measured strength DET₃ are all equal to the lower threshold, the blocker detection circuit 34 may not be able to conclusively determine a presence or absence of the out-band RF blockers 12, 14, and 16. In this regard, the blocker detection circuit 34 may further enhance detectability of the nearby out-band RF blocker 12, the intermediate out-band RF blocker 14, and the far-out out-band RF blocker 16 by further including the fourth measured strength DET₄. As an example, the blocker detection circuit 34 may detect the far-out out-band RF blocker 16 by further examining the third measured strength DET₃ and the fourth measured strength DET₄.

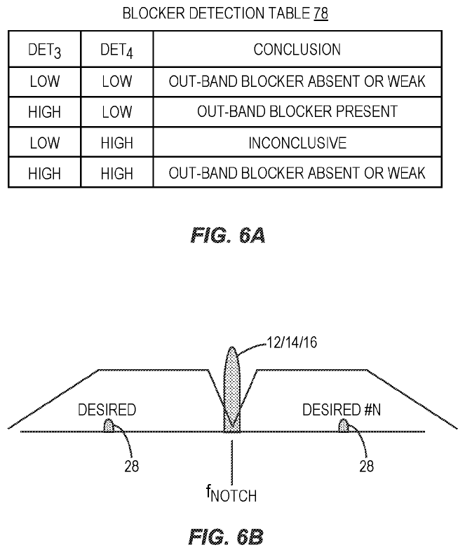

In an embodiment, the HRF 36 can be a notch filter. In this regard, the blocker detection circuit 34 may determine whether any of the out-band RF blockers 12, 14, and 16 is present at a notch frequency of the HRF 36. FIGS. 6A and 6B provide exemplary illustrations as to how the blocker detection circuit 34 in FIG. 2 can detect the out-band RF blockers 12, 14, and 16 in FIG. 1 at a notch frequency f_{NOTCH}. Common elements between FIGS. 1, 2, 6A, and 6B are shown therein with common element numbers and will not be re-described herein.

In an embodiment, the blocker detection circuit 34 may determine whether any of the out-band RF blockers 12, 14, and 16 is present at the notch frequency f_{NOTCH} based on the third measured strength DET₃ and the fourth measured strength DET₄. FIG. 6A shows a blocker detection table 78 that establishes a set of rules that the blocker detection circuit 34 may employ to determine whether any of the out-band RF blockers 12, 14, and 16 is present at the notch frequency f_{NOTCH}.

According to the blocker detection table 78, the blocker detection circuit 34 can conclude that one or more of the out-band RF blockers 12, 14, and 16 is present at the notch frequency f_{NOTCH} if the third measured strength DET₃ is equal to the higher threshold and the fourth measured strength DET₄ is equal to the lower threshold. Also, according to the blocker detection table 78, the blocker detection circuit 34 can conclude that the out-band RF blockers 12, 14, and 16 may be absent or too weak to be of concern when the third measured strength DET₃ and the fourth measured strength DET₄ are both equal to the lower threshold or the higher threshold. However, in case the third measured strength DET₃ is equal to the lower threshold and the fourth measured strength DET₄ is equal to the higher threshold, the blocker detection circuit 34 may not conclusively determine whether any of the out-band RF blockers 12, 14, and 16 is present or absent at the notch frequency f_{NOTCH}.

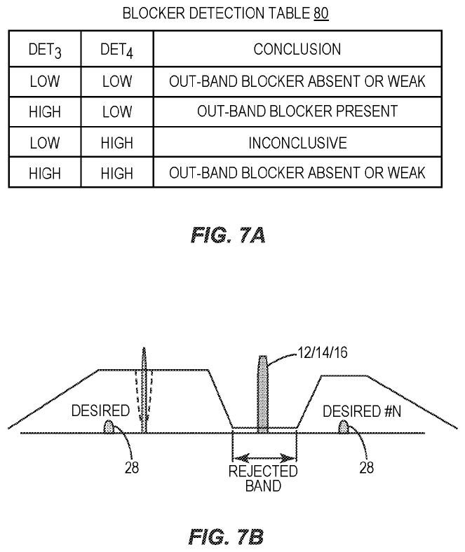

In another embodiment, the HRF 36 can be a band reject filter. In this regard, the blocker detection circuit 34 may determine whether any of the out-band RF blockers 12, 14, and 16 is present at a rejected band of the HRF 36. FIGS. 7A and 7B provide exemplary illustrations as to how the blocker detection circuit 34 in FIG. 2 can detect the out-bad RF blockers 12, 14, and 16 in FIG. 1 in a rejected band of the HRF 36. Common elements between FIGS. 1, 2, 7A, and 7B are shown therein with common element numbers and will not be re-described herein.

In an embodiment, the blocker detection circuit 34 may determine whether any of the out-band RF blockers 12, 14, and 16 is present in the rejected band based on the third measured strength DET₃ and the fourth measured strength DET₄. FIG. 7A shows a blocker detection table 80 that establishes a set of rules that the blocker detection circuit 34 may employ to determine whether any of the out-band RF blockers 12, 14, and 16 is present in the rejected band.

According to the blocker detection table 78, the blocker detection circuit 34 can conclude that one or more of the out-band RF blockers 12, 14, and 16 is present in the rejected band if the third measured strength DET₃ is equal to the higher threshold and the fourth measured strength DET₄ is equal to the lower threshold. Also, according to the blocker detection table 78, the blocker detection circuit 34 can conclude that the out-band RF blockers 12, 14, and 16 may be absent or too weak to be of concern when the third measured strength DET₃ and the fourth measured strength DET₄ are both equal to the lower threshold or the higher threshold. However, in case the third measured strength DET₃ is equal to the lower threshold and the fourth measured strength DET₄ is equal to the higher threshold, the blocker detection circuit 34 may not conclusively determine whether any of the out-band RF blockers 12, 14, and 16 is present or absent in the rejected band.

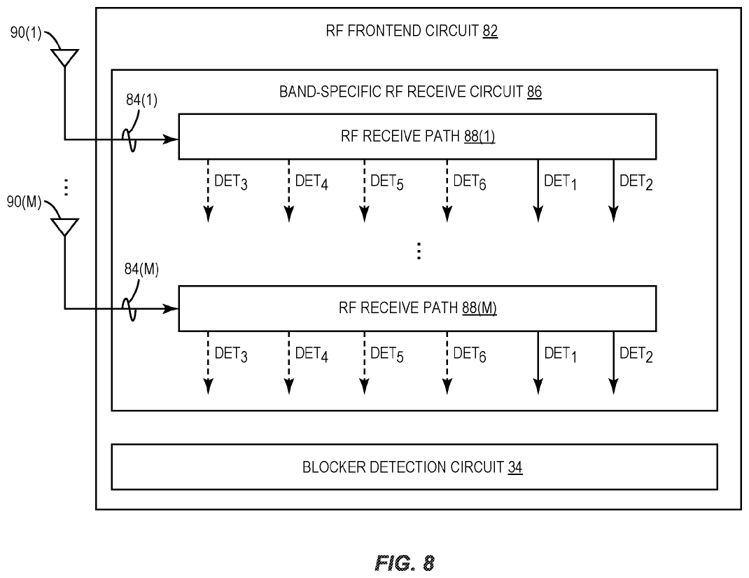

The RF frontend circuit 22 may be adapted to concurrently detect the RF blockers 10, 12, 14, and 16 in FIG. 1 in multiple RF signals. In this regard, Figurer 8 is a schematic diagram of an exemplary RF frontend circuit 82 configured according to another embodiment of the present disclosure to concurrently detect the RF blockers 10, 12, 14, and 16 in FIG. 1 in multiple RF signals 84(1)-84(M). Common elements between FIGS. 2 and 8 are shown therein with common element numbers and will not be re-described herein.

The RF frontend circuit 82 can include a band-specific RF receive circuit 86, which can concurrently receive the RF signals 84(1)-84(M) in a specific RF band, such as in the case of carrier aggregation (CA). The band-specific RF receive circuit 86 can include multiple RF receive paths 88(1)-88(M). Each of the RF receive paths 88(1)-88(M) is coupled to a respective one of multiple antenna circuits 90(1)-90(M) to receive a respective one of the RF signals 84(1)-84(M).

Herein, each of the RF receive paths 88(1)-88(M) is identical to the RF receive path 24 in FIG. 2. As such, the blocker detection circuit 34 may detect the RF blockers 10, 12, 14, and 16 associated with any of the RF signals 84(1)-84(M) in a same manner as in the RF frontend circuit 22 of FIG. 2.

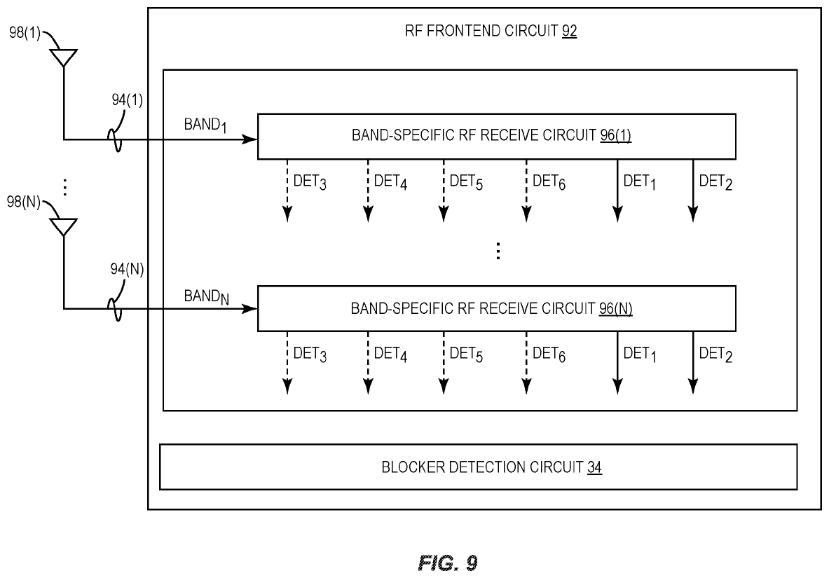

The RF frontend circuit 22 may also be adapted to concurrently detect the RF blockers 10, 12, 14, and 16 in FIG. 1 in multiple RF signals and across multiple RF bands. In this regard, Figurer 9 is a schematic diagram of an exemplary RF frontend circuit 92 configured according to another embodiment of the present disclosure to concurrently detect the RF blockers 10, 12, 14, and 16 in FIG. 1 in multiple RF signals 94(1)-94(N) across multiple RF bands Bandᵢ-Band_{N}. Common elements between FIGS. 2 and 9 are shown therein with common element numbers and will not be re-described herein.

The RF frontend circuit 92 can include multiple band-specific RF receive circuits 96(1)-96(N). Each of the band-specific RF receive circuits 96(1)-96(N) is coupled to a respective one of multiple antenna circuits 98(1)-98(N) to receive a respective one of the RF signals 94(1)-94(N) in a respective one of the RF bands Band₁-Band_{N}.

Herein, each of the band-specific RF receive circuits 96(1)-96(N) is identical to the band-specific RF receive circuit 86 in FIG. 8. In this regard, each of the RF signals 94(1)-94(N) can be equivalent to the RF signals 84(1)-84(M), and each of the antenna circuits 98(1)-98(N) can be equivalent to the antenna circuits 90(1)-90(M). Accordingly, the blocker detection circuit 34 may detect the RF blockers 10, 12, 14, and 16 associated with any of the RF signals 84(1)-84(M) in a same manner as in the RF frontend circuit 22 of FIG. 2 or in the RF frontend circuit 82 of FIG. 8.

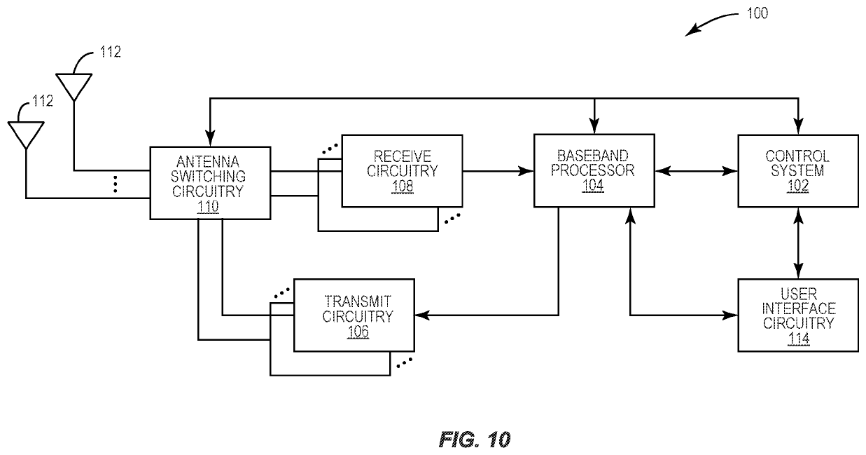

The RF frontend circuit 22 of FIG. 2, the RF frontend circuit 82 of FIG. 8, and the RF frontend circuit 92 of FIG. 9 can be provided in a user element to enable bandwidth adaptation according to embodiments described above. In this regard, FIG. 10 is a schematic diagram of an exemplary user element 100 wherein the RF frontend circuit 22 of FIG. 2, the RF frontend circuit 82 of FIG. 8, and the RF frontend circuit 92 of FIG. 9 can be provided.

Herein, the user element 100 can be any type of user elements, such as mobile terminals, smart watches, tablets, computers, navigation devices, access points, and like wireless communication devices that support wireless communications, such as cellular, wireless local area network (WLAN), Bluetooth, and near field communications. The user element 100 will generally include a control system 102, a baseband processor 104, transmit circuitry 106, receive circuitry 108, antenna switching circuitry 110, multiple antennas 112, and user interface circuitry 114. In a non-limiting example, the control system 102 can be a field-programmable gate array (FPGA), as an example. In this regard, the control system 102 can include at least a microprocessor(s), an embedded memory circuit(s), and a communication bus interface(s). The receive circuitry 108 receives radio frequency signals via the antennas 112 and through the antenna switching circuitry 110 from one or more base stations. A low noise amplifier and a filter cooperate to amplify and remove broadband interference from the received signal for processing. Downconversion and digitization circuitry (not shown) will then downconvert the filtered, received signal to an intermediate or baseband frequency signal, which is then digitized into one or more digital streams using analog-to-digital converter(s) (ADC).

The baseband processor 104 processes the digitized received signal to extract the information or data bits conveyed in the received signal. This processing typically comprises demodulation, decoding, and error correction operations, as will be discussed in greater detail below. The baseband processor 104 is generally implemented in one or more digital signal processors (DSPs) and application specific integrated circuits (ASICs).

For transmission, the baseband processor 104 receives digitized data, which may represent voice, data, or control information, from the control system 102, which it encodes for transmission. The encoded data is output to the transmit circuitry 106, where a digital-to-analog converter(s) (DAC) converts the digitally encoded data into an analog signal and a modulator modulates the analog signal onto a carrier signal that is at a desired transmit frequency or frequencies. A power amplifier will amplify the modulated carrier signal to a level appropriate for transmission and deliver the modulated carrier signal to the antennas 112 through the antenna switching circuitry 110. The multiple antennas 112 and the replicated transmit and receive circuitries 106, 108 may provide spatial diversity. Modulation and processing details will be understood by those skilled in the art.

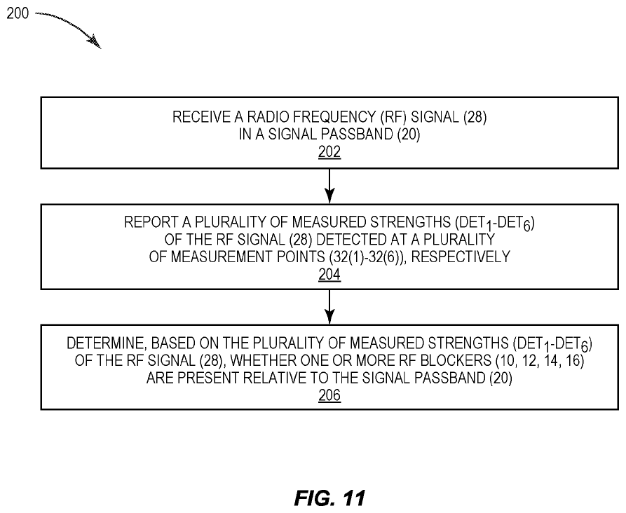

The RF frontend circuit 22 of FIG. 2 can be configured to detect the RF blockers 10, 12, 14, and/or 16 based on a process. In this regard, FIG. 11 is a flowchart of an exemplary process 200 whereby the RF frontend circuit 22 of FIG. 2 can detect the RF blockers 10, 12, 14, and/or 16 in FIG. 1.

Herein, the RF receive path 24 receives the RF signal 28 in the signal passband 20 (step 202). The detector circuits 30(1)-30(6) are configured to report the measured strengths DET₁-DET₆ of the RF signal 28 detected at the measurement points 32(1)-32(6), respectively (step 204). Accordingly, the blocker detection circuit 34 can determine whether the RF blockers 10, 12, 14, and/or 16 are present relative to the signal passband 20 based on the measured strengths DET₁-DET₆ of the RF signal 28 (step 206).

Those skilled in the art will recognize improvements and modifications to the embodiments of the present disclosure. All such improvements and modifications are considered within the scope of the concepts disclosed herein and the claims that follow.

1. A radio frequency (RF) frontend circuit comprising:
at least one RF receive path configured to receive an RF signal in a signal passband;
a plurality of detector circuits each coupled to a respective one of a plurality of measurement points in the at least one RF receive path and configured to report a respective one of a plurality of measured strengths of the RF signal detected at the respective one of the plurality of measurement points; and
a blocker detection circuit coupled to the plurality of detector circuits and configured to determine, based on the plurality of measured strengths of the RF signal, whether one or more RF blockers are present relative to the signal passband.

2. The RF frontend circuit of claim 1, wherein the blocker detection circuit is further configured to report the one or more detected RF blockers to a transceiver circuit coupled to the RF frontend circuit in response to determining the presence of the one or more RF blockers.

3. The RF frontend circuit of claim 1, wherein the blocker detection circuit is further configured to cause a corrective action to be taken in the RF frontend circuit to suppress the one or more detected RF blockers in response to determining the presence of the one or more RF blockers.

4. The RF frontend circuit of claim 1, wherein the at least one RF receive path comprises:
a harmonic rejection filter coupled to an antenna circuit;
a band select filter coupled to the harmonic rejection filter;
a low-noise amplifier (LNA) coupled to the band select filter; and
a post-LNA tunable filter coupled to an output of the LNA.

5. The RF frontend circuit of claim 4, wherein the plurality of detector circuits comprises:
a first detector circuit coupled to a first one of the plurality of measurement points located at an input of the post-LNA tunable filter and configured to report a first measured strength among the plurality of measured strengths of the RF signal as detected at the input of the post-LNA tunable filter; and
a second detector circuit coupled to a second one of the plurality of measurement points located at an output of the post-LNA tunable filter and configured to report a second measured strength among the plurality of measured strengths of the RF signal as detected at the output of the post-LNA tunable filter.

6. The RF frontend circuit of claim 5, wherein the blocker detection circuit is further configured to determine that at least one in-band RF blocker is present inside the signal passband in response to the first measured strength being higher than an established threshold and the second measured strength being lower than the established threshold.

7. The RF frontend circuit of claim 6, wherein the blocker detection circuit is further configured to determine a location of the at least one in-band RF blocker relative to the signal passband.

8. The RF frontend circuit of claim 5, wherein the plurality of detector circuits comprises a third detector circuit coupled to a third one of the plurality of measurement points located at an input of the harmonic rejection filter and configured to report a third measured strength among the plurality of measured strengths of the RF signal as detected at the input of the harmonic rejection filter.

9. The RF frontend circuit of claim 8, wherein the blocker detection circuit is further configured to determine a presence of a nearby out-band RF blocker, an intermediate out-band RF blocker, or a far-out out-band RF blocker based on a lower threshold, a medium threshold higher than the lower threshold, and a higher threshold higher than the medium threshold.

10. The RF frontend circuit of claim 9, wherein the blocker detection circuit is further configured to determine that at least one nearby out-band RF blocker is present outside the signal passband in response to:
the first measured strength and the second measured strength being equal to the medium threshold; and
the third measured strength being equal to one of the medium threshold and the higher threshold.

11. The RF frontend circuit of claim 9, wherein the blocker detection circuit is further configured to determine that at least one far-out out-band RF blocker is present outside the signal passband in response to:
the first measured strength being equal to the medium threshold;
the second measured strength being equal to the lower threshold; and
the third measured strength being equal to one of the medium threshold and the higher threshold.

12. The RF frontend circuit of claim 9, wherein the blocker detection circuit is further configured to determine that at least one intermediate out-band RF blocker is present outside the signal passband in response to:
the first measured strength and the second measured strength being equal to the lower threshold; and
the third measured strength being equal to the higher threshold.

13. The RF frontend circuit of claim 8, wherein the plurality of detector circuits comprises a fourth detector circuit coupled to a fourth one of the plurality of measurement points located at an output of the harmonic rejection filter and configured to report a fourth measured strength among the plurality of measured strengths of the RF signal as detected at the output of the harmonic rejection filter.

14. The RF frontend circuit of claim 13, wherein the plurality of detector circuits comprises a fifth detector circuit coupled to a fifth one of the plurality of measurement points located at an input of the band select filter and configured to report a fifth measured strength among the plurality of measured strengths of the RF signal as detected at the input of the band select filter.

15. The RF frontend circuit of claim 14, wherein:
the at least one RF receive path further comprises a pre-LNA tunable filter coupled to an input of the LNA; and
the plurality of detector circuits comprises a sixth detector circuit coupled to a sixth one of the plurality of measurement points located at an input of the pre-LNA tunable filter and configured to report a sixth measured strength among the plurality of measured strengths of the RF signal as detected at the input of the pre-LNA tunable filter.

16. A method for detecting a radio frequency (RF) blocker in a signal passband comprising:
receiving an RF signal in the signal passband;
reporting a plurality of measured strengths of the RF signal detected at a plurality of measurement points, respectively; and
determining, based on the plurality of measured strengths of the RF signal, whether one or more RF blockers are present relative to the signal passband.

17. The method of claim 16, further comprising determining that at least one in-band RF blocker is present inside the signal passband in response to a first measured strength among the plurality of measured strengths being higher than an established threshold and a second measured strength among the plurality of measured strengths being lower than the established threshold.

18. The method of claim 17, further comprising determining a location of the at least one in-band RF blocker relative to the signal passband.

19. The method of claim 17, further comprising determining a presence of a nearby out-band RF blocker, an intermediate out-band RF blocker, or a far-out out-band RF blocker based on a lower threshold, a medium threshold higher than the lower threshold, and a higher threshold higher than the medium threshold.

20. The method of claim 16, further comprising reporting the one or more detected RF blockers to a transceiver circuit in response to determining the presence of the one or more RF blockers.
